(19) United States
(12) Patent Application Publication
(10) Pub. No.: US 2026/0045235 A1
(43) Pub. Date: Feb. 12, 2026

(54) Method and Apparatus for Controlling Source Driver, and Display System

(71) Applicants: Analogix (Suzhou) Semiconductor Co., LTD., Suzhou, Jiangsu (CN); ANALOGIX INTERNATIONAL LLC, WiImington, DE (US)

(72) Inventors: Hao YANG, Suzhou, Jiangsu (CN); Zhibin LIU, Suzhou, Jiangsu (CN)

(21) Appl. No.: 18/268,317

(22) PCT Filed: Nov. 14, 2022
(86) PCT No.: PCT/CN2022/131758

§ 371 Date: Oct. 1, 2025

(30) Foreign Application Priority Data
Oct. 18, 2022 (CN) 202211275058.8

(51) Int. Cl. G09G 3/36; G09G 3/20

(52) U.S. Cl. CPC G09G 3/3685; G09G 3/2074; G09G 3/3614; G09G 2310/0248; G09G 2310/027; G09G 2310/0291; G09G 2310/08; G09G 2330/023

(57) ABSTRACT

Provided in the present disclosure are a method and an apparatus for controlling a source driver, and a display system. The method includes: in a case that the source driver is in a charging state, acquiring a plurality of first voltages and a plurality of second voltages, and calculating a plurality of third voltages; according to each the first voltage, each the corresponding second voltage and the corresponding third voltage, determining, in a case that data of the next row are sent to the data channel after each the switch device is closed, whether a first power-saving quantity is greater than a first predetermined threshold, and/or whether a second power-saving quantity is greater than a second predetermined threshold; and in a case that the first power-saving quantity is greater than the first predetermined threshold, and/or the second power-saving quantity is greater than the second predetermined threshold, controlling each the switch device of a target source driver to be closed, and then sending the data of the next row to each the corresponding data channel, and the target source driver is the source driver whose the first power-saving quantity is greater than the first preset threshold, or all of the source drivers. Therefore, by means of the present disclosure, the problem of high power consumption of a source driver is solved.

This application claims priority to patent application No. 202211275058.8 filed on Oct. 18, 2022 and entitled “Method and Apparatus for Controlling Source Driver, and Display System”, the disclosure of which is hereby incorporated by reference in its entirety.

### TECHNICAL FIELD

The present disclosure relates to the field of display, and specifically, to a method and an apparatus for controlling a source driver, and a computer-readable storage medium, a processor, a timing controller and a display system.

### BACKGROUND

With the development of liquid crystal displays towards high integration, high resolution, and multi-grayscale, the power consumption of corresponding source driving chips becomes greater and greater. Therefore, how to reduce the power consumption of the source driver of a display screen during charging so as to save the power of the source driver is an urgent problem to be solved in the prior art.

The above information disclosed in Background is only intended to enhance the understanding of the background of the technology described herein, such that the Background may include certain information that does not form the prior art known in this country to those skilled in the art.

### SUMMARY

The present disclosure is mainly intended to provide a method and an apparatus for controlling a source driver, and a computer-readable storage medium, a processor, a timing controller and a display system, so as to solve the problem in the prior art of high power consumption of a source driver during charging.

An aspect of an embodiment of the present disclosure provides a method for controlling a source driver. There is at least one source driver to be controlled, the source driver includes a plurality of channel groups, the channel group includes a plurality of data channels with same polarity which are arranged in order, and any two of the plurality of the data channels in the channel group are connected by means of a switch device; and the method includes: an acquisition step: in a case that the source driver is in a charging state, a plurality of first voltages and a plurality of second voltages are acquired, and a plurality of third voltages are calculated, and the first voltage is a data voltage of a current row of the data channel, the second voltage is a data voltage of a next row of the current row of the data channel, and the third voltage is a data voltage of the current row of the data channel in a case that each the switch device is closed; a determination step: according to each of the plurality of the first voltages, each of the plurality of the second voltages corresponding to the plurality of the first voltages and each of the plurality of the third voltages corresponding to the plurality of the first voltages, it is determined, in a case that data of the next row are sent to the data channel after each the switch device is closed, that whether at least one of following is met: whether a first power-saving quantity being greater than a first predetermined threshold, whether a second power-saving quantity being greater than a second predetermined threshold, and the first power-saving quantity is a power-saving quantity of the source driver, and the second power-saving quantity is a sum of power-saving quantities of all of source drivers; and a first control step: in a case that at least one of following is met: the first power-saving quantity being greater than the first predetermined threshold, the second power-saving quantity being greater than the second predetermined threshold, each the switch device of a target source driver is controlled to be closed, and then the data of the next row are sent to each of the plurality of the data channels corresponding to the data of the next row, and the target source driver is the source driver whose the first power-saving quantity is greater than the first preset threshold, or the target source driver is all of the source drivers.

Optionally, the plurality of the data channels are correspondingly connected to linear buffers on a one-to-one base; and in the case that the source driver is in the charging state, acquiring the plurality of the first voltages and the plurality of the second voltages, and calculating the plurality of the third voltages includes: in a case that the source driver is in the charging state and a inversion mode of the source driver is a column inversion mode, it is determined that whether a display pattern corresponding to data of the current row is a preset pattern, and the preset pattern is a pattern displayed by a preset display device; in a case that the display pattern is the preset pattern, the data voltage of the current row stored in each linear buffer is read, so as to obtain the plurality of the first voltages; video data are received, and the data voltage of the next row is extracted from the video data, so as to obtain the second voltage; and an average value of the plurality of the first voltages of each of the plurality of the data channels in the same channel group is calculated, so as to obtain the third voltage corresponding to each of the plurality of the data channels.

Optionally, according to each of the plurality of the first voltages, each of the plurality of the second voltages corresponding to the plurality of the first voltages and each of the plurality of the third voltages corresponding to the plurality of the first voltages, in the case that the data of the next row are sent to the data channel after each the switch device is closed, it is determined that whether the first power-saving quantity is greater than the first predetermined threshold includes: according to the first voltage, the second voltage corresponding to the first voltage and the third voltage corresponding to the first voltage, in the case that the data of the next row are sent to the data channel after each the switch device is closed, it is determined that whether the data channel is power-saving, and a voltage-saving quantity of the data channel, in a case that the data channel is power-saving, it is determined that the voltage-saving quantity is a positive number, and in a case that the data channel is not power-saving, it is determined that the voltage-saving quantity is a negative number; each of the voltage-saving quantities corresponding to the source driver is added, so as to obtain the first power-saving quantity; and whether the first power-saving quantity is greater than the first predetermined threshold is determined.

Optionally, according to the first voltage, the second voltage corresponding to the first voltage and the third voltage corresponding to the first voltage, in the case that the data of the next row are sent to the data channel after each the switch device is closed, it is determined that whether the data channel is power-saving includes: in a case that the first voltage, the third voltage and the second voltage are increased or decreased in order, in the case that the data of the next row are sent to the data channel after each the switch device is closed, it is determined that the data channel is power-saving; and in a case that the third voltage is separately greater than or less than the first voltage and the second voltage, in the case that the data of the next row are sent to the data channel after each the switch device is closed, it is determined that the data channel is not power-saving.

Optionally, in the case that the data of the next row are sent to the data channel after each the switch device is closed, it is determined that the voltage-saving quantity of the data channel includes: in a case that the data channel is power-saving, it is determined that the voltage-saving quantity is an absolute value of a difference between the first voltage and the third voltage; in a case that the data channel is not power-saving and both the second voltage and the third voltage are greater than or less than the first voltage, it is determined that the voltage-saving quantity is a negative number of the absolute value of the difference between the first voltage and the third voltage; and in a case that the data channel is not power-saving and both the second voltage and the third voltage are not greater than or less than the first voltage, it is determined that the voltage-saving quantity is a negative number of an absolute value of a difference between the second voltage and the third voltage.

Optionally, there are a plurality of the source drivers; and according to each of the plurality of the first voltages, each of the plurality of the second voltages corresponding to the plurality of the first voltages and each of the plurality of the third voltages corresponding to the plurality of the first voltages, in the case that the data of the next row are sent to the data channel after each the switch device is closed, it is determined that whether the second power-saving quantity is greater than the second predetermined threshold includes: each the first power-saving quantity is determined according to each of the plurality of the first voltages, each of the plurality of the second voltages corresponding to the plurality of the first voltages and each of the plurality of the third voltages corresponding to the plurality of the first voltages; and first power-saving quantities are added, so as to obtain the second power-saving quantity, and it is determined that whether the second power-saving quantity is greater than the second predetermined threshold.

Optionally, the source driver further includes a control module, each the switch device of the target source driver is controlled to be closed includes: a data packet is generated, and the data packet is sent to the control module of the target source driver, and the data packet is used for instructing the control module of the target source driver to close each the switch device.

Optionally, in a case that the first power-saving quantity is less than or equal to the first predetermined threshold, or the second power-saving quantity is less than or equal to the second predetermined threshold, the method further includes: a second control step: each the switch device of the target source driver is controlled to turn off, and then the data of the next row are sent to each of the plurality of the data channels corresponding to the data of the next row.

Optionally, after the control step, the method further includes: the acquisition step, the determination step, and the first control step or the second control step are successively executed for at least once, until all row data of video data are sent to the plurality of the data channels corresponding to the data of the next row.

Another aspect of the embodiment of the present disclosure provides an apparatus for controlling a source driver. There is at least ‘one source driver to be controlled, the source driver includes a plurality of channel groups, the channel group includes a plurality of data channels with same polarity which are arranged in order, and any two of the plurality of the data channels in the channel group are connected by means of a switch device; and the apparatus includes: an acquisition component, configured to perform an acquisition step: in a case that the source driver is in a charging state, a plurality of first voltages and a plurality of second voltages are acquired, and a plurality of third voltages are calculated, and the first voltage is a data voltage of a current row of the data channel, the second voltage is a data voltage of a next row of the current row of the data channel, and the third voltage is a data voltage of the current row of the data channel in a case that each the switch device is closed; a determination component, configured to perform a determination step: according to each of the plurality of the first voltages, each of the plurality of the second voltages corresponding to the plurality of the first voltages and each of the plurality of the third voltages corresponding to the plurality of the first voltages, it is determined, in a case that data of the next row are sent to the data channel after each the switch device is closed, that whether at least one of following is met: whether a first power-saving quantity being greater than a first predetermined threshold, whether a second power-saving quantity being greater than a second predetermined threshold, and the first power-saving quantity is a power-saving quantity of the source driver, and the second power-saving quantity is a sum of power-saving quantities of all of source drivers; and a first control component, configured to perform a first control step: in a case that at least one of following is met: the first power-saving quantity being greater than the first predetermined threshold, the second power-saving quantity being greater than the second predetermined threshold, each the switch device of a target source driver is controlled to be closed, and then the data of the next row are sent to each of the plurality of the data channels corresponding to the data of the next row, and the target source driver is the source driver whose the first power-saving quantity is greater than the first preset threshold, or the target source driver is all of the source drivers.

Still another aspect of the embodiment of the present disclosure further provides a computer-readable storage medium. The computer-readable storage medium includes a program stored, and the program executes any one of the methods described.

Another aspect of the embodiment of the present disclosure further provides a processor, the processor is configured to operate a program, and any one of the methods described is executed when the program is operated.

Still another aspect of the embodiment of the present disclosure further provides a timing controller. The timing controller includes one or more processors, a memory, and one or more programs, and the one or more programs are stored in the memory, and are configured to be executed by the one or more processors; and the one or more programs include instructions that are used for executing any one of the methods described.

Another aspect of the embodiment of the present disclosure further provides a display system. The display system includes a display device, at least one source driver and the timing controller, and an output of the source driver is connected to the display device, and the source driver includes a plurality of channel groups, the channel group includes a plurality of data channels with same polarity which are arranged in order, and any two of the plurality of the data channels in the channel group are connected by means of a switch device; and the timing controller is connected to an input of the source driver.

Optionally, each of the plurality of the channel groups separately has three data channels.

By means of the technical solutions of the present disclosure, in the method for controlling the source driver, firstly, when the source driver is in the charging state, the plurality of the first voltages and the plurality of the second voltages are acquired, and the plurality of the third voltages are calculated, and the first voltage is the data voltage of the current row of the data channel, the second voltage is the data voltage of the next row of the current row of the data channel, and the third voltage is the data voltage of the current row of the data channel when each of the switch devices is closed; then, according to the acquired first voltage, the second voltage and the third voltage, when the data of the next row are sent to the data channel after each of the switch devices is closed, whether at least one of the following is met is determined: whether a power-saving requirement of the single source driver is met, whether power-saving requirements of all of the source drivers are met; and finally, when the power-saving requirements are met, charge sharing control is executed, that is, each of the switch devices of the target source driver is controlled to be closed, and then the data of the next row are sent to each of the corresponding data channels. In the present disclosure, by means of the plurality of the first voltages, the second voltages and the third voltages, when each of the switch devices is opened, at least one of the following is determined: whether the power-saving quantity of the source driver is greater than the predetermined threshold, the power-saving quantities of all of the source drivers are greater than the predetermined threshold; and if the power-saving quantity is greater than the predetermined threshold, the switch of the source driver is controlled to be closed, so as to perform charge sharing on the data channels in each of the channel groups, and the data of the next row are sent to each of the data channels. In this way, the power of the source driver during charging is saved, such that the power consumption of the entire display can be reduced, and the problem in the prior art of high power consumption of the source driver during charging is effectively solved.

### BRIEF DESCRIPTION OF THE DRAWINGS

The accompanying drawings constituting a part of the present disclosure are used to provide a further understanding of the present disclosure. The exemplary embodiments of the present disclosure and the description thereof are used to explain the present disclosure, but do not constitute improper limitations to the present disclosure. In the drawings:

FIG. 1 is a schematic diagram of channel groups in a source driver according to an embodiment of the present disclosure.

FIG. 2 is a method flowchart of a method for controlling a source driver according to an embodiment of the present disclosure.

FIG. 3 is another method flowchart of a method for controlling a source driver according to an embodiment of the present disclosure.

FIG. 4 and FIG. 5 respectively are relationship diagrams of voltages in a power-saving case according to an embodiment of the present disclosure.

FIG. 6 and FIG. 7 respectively are relationship diagrams of voltages in a non-power-saving case according to an embodiment of the present disclosure.

FIG. 8 is still another method flowchart of a method for controlling a source driver according to an embodiment of the present disclosure.

FIG. 9 is a structural diagram of an apparatus for controlling a source driver according to an embodiment of the present disclosure.

### DETAILED DESCRIPTION OF THE EMBODIMENTS

It is to be noted that the embodiments in the present disclosure and the features in the embodiments may be combined with one another without conflict. The present disclosure will be described below in detail with reference to the drawings and the embodiments.

In order to enable those skilled in the art to better understand the solutions of the present disclosure, the technical solutions in the embodiments of the present disclosure will be clearly and completely described below in combination with the drawings in the embodiments of the present disclosure. It is apparent that the described embodiments are only part of the embodiments of the present disclosure, not all the embodiments. Based on the embodiments in the present disclosure, all other embodiments obtained by those ordinary skilled in the art without creative work shall all fall within the protection scope of the present disclosure.

It is to be noted that terms “first”, “second” and the like in the description, claims and the above-mentioned drawings of the present disclosure are used for distinguishing similar objects rather than describing a specific sequence or a precedence order. It should be understood that the data used in such a way may be exchanged where appropriate, in order that the embodiments of the disclosure described here can be implemented. In addition, terms “include” and “have” and any variations thereof are intended to cover non-exclusive inclusions. For example, it is not limited for processes, methods, systems, products or devices containing a series of steps or components to clearly list those steps or components, and other steps or components which are not clearly listed or are inherent to these processes, methods, products or devices may be included instead.

It should be understood that, when an element (such as a layer, a film, a region, or a substrate) is described as being “on” another element, the element may be directly on that other element, or there may be an intermediate element. In addition, in the description and the claims, when an element is described as “connected” to another element, the element may be “directly connected” to the other element or “connected” to the other element via a third element.

As described in Background, the power consumption of a source driver during charging in the prior art is relatively high. In order to solve the above problem, a typical implementation of the present disclosure provides a method and an apparatus for controlling a source driver, and a computer-readable storage medium, a processor, a timing controller and a display system.

An embodiment of the present disclosure provides a method for controlling a source driver. There is at least one source driver to be controlled. The source driver includes a plurality of channel groups, the channel group includes a plurality of data channels with same polarity which are arranged in order, and any two of the plurality of the data channels in the channel group are connected by means of a switch device. The above expression of being arranged in order may be represented to be arranged according to columns, or be arranged according to rows.

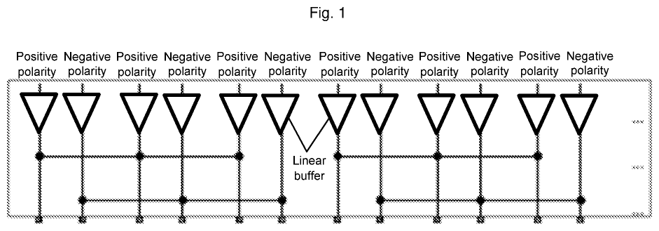

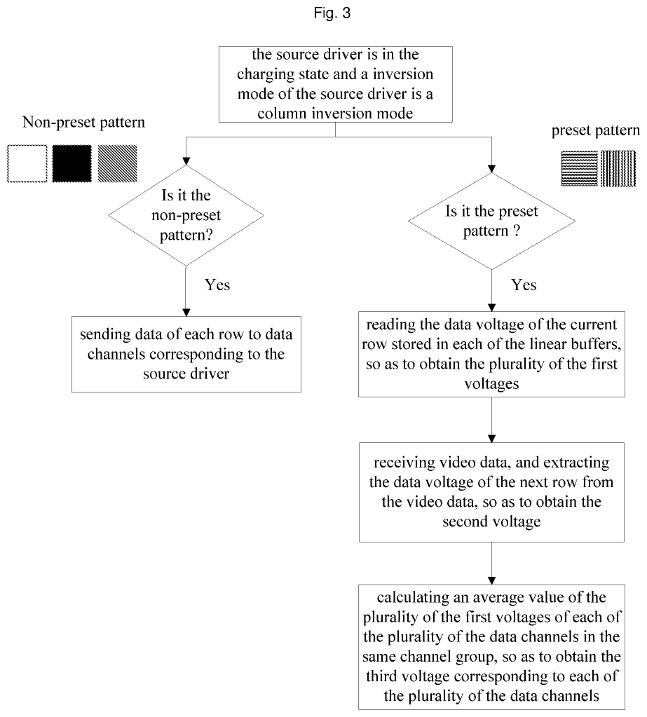

In an actual application, as shown in FIG. 1, in the source driver, the data channels are arranged according to a column sequence (that is, in a vertical direction), and the data channels with positive and negative polarity are arranged alternately. That is to say, both two adjacent sides of the data channel with positive polarity are the data channels with negative polarity. In the channel group, the plurality of adjacent data channels with the same polarity are connected by means of switch devices. The number of the data channels connected may be flexibly set according to actual requirements. For example, 3 data channels are connected as a group used as the channel group, 4 data channels are connected as a group used as the channel group, and so on. FIG. 3 shows an example of 3 data channels connected as a group used as the channel group.

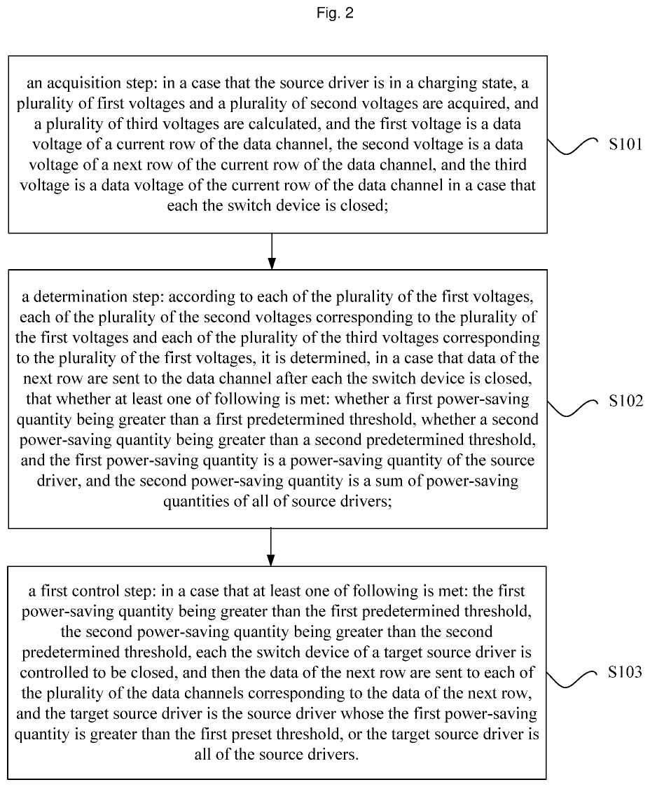

FIG. 2 is a flowchart of a method for controlling a source driver according to an embodiment of the present disclosure. As shown in FIG. 2, the method includes the following steps:
step S101, an acquisition step: in a case that the source driver is in a charging state, a plurality of first voltages and a plurality of second voltages are acquired, and a plurality of third voltages are calculated, and the first voltage is a data voltage of a current row of the data channel, the second voltage is a data voltage of a next row of the current row of the data channel, and the third voltage is a data voltage of the current row of the data channel in a case that each the switch device is closed;
The rows in the row data may be horizontal or vertical, and are perpendicular to an arrangement direction of the data channels. The data of the current row and the data of the next row are sub-pixel data.

The method provided in this embodiment of the present disclosure may be applied to a timing controller. As shown in FIG. 1, the plurality of the data channels are correspondingly connected to linear buffers on a one-to-one base. The process of, in the case that the source driver is in the charging state, acquiring the plurality of the first voltages and the plurality of the second voltages, and calculating the plurality of the third voltages is shown in FIG. 3, and is specifically described as follows:
step S201, in a case that the source driver is in the charging state and a inversion mode of the source driver is a column inversion mode, it is determined whether a display pattern corresponding to data of the current row is a preset pattern, and the preset pattern is a pattern displayed by a preset display device;
step S202, in a case that the display pattern is the preset pattern, the data voltage of the current row stored in each of the linear buffers is read, so as to obtain the plurality of the first voltages;
step S203, video data are received, and the data voltage of the next row is extracted from the video data, so as to obtain the second voltage.
step S204, an average value of the plurality of the first voltages of each of the plurality of the data channels in the same channel group is calculated, so as to obtain the third voltage corresponding to each of the plurality of the data channels.

When the source driver is in the charging state and the inversion mode thereof is column inversion (which may also be called row inversion), the display pattern corresponding to the data of the current row is further required to be determined, that is, whether the display pattern of the display is the preset pattern; and if the display pattern is the preset pattern, subsequent actions of data acquisition, power-saving quantity calculation and charge sharing control are executed. That is to say, in the present disclosure, the charging sharing control of the source driver is combined with a special pattern, that is, when the special pattern is displayed and the power-saving quantity meets requirements, charging sharing control is performed on the source driver. In this way, the charge quantity of the source driver during charging may be effectively reduced, thereby guaranteeing low power consumption of the entire display device.

The preset pattern may be another pattern other than black, white and gray patterns, for example, red, green and blue patterns, stripe patterns shown in FIG. 3, checkerboard patterns, or the like. Definitely, the preset pattern is not limited to the above patterns. Those skilled in the art may flexibly design any display pattern as the preset pattern according to the requirements of chip manufacturers. Generally, the designed preset pattern is a pattern that has high power consumption during scanning and display.

It is to be noted that, the control method of the present disclosure is not applicable to the control of the source driver of which inversion mode is dot inversion mode. In addition, a power-saving or non-power-saving situation is calculated only at a charging state, and inspection is not required at a discharging state. In short, when the power consumption of charge sharing is calculated, only a rising situation is summarized. As a falling situation is only a discharging situation, when the source driver is in a discharging state or the inversion mode of the source driver is dot inversion mode, the timing controller transmits, according to an existing processing mode, the data of each row to the data channel corresponding to the source driver. The data of the current row is the video data which have currently been inputted into the data channel, and the data of the next row is the data that are adjacent to the current row, have not yet been inputted and to be inputted to the data channel.

The linear buffer is used for buffering the data of the current row that have been inputted into the data channel; and after the data of the next row are inputted into the data channel, the data buffered in the linear buffer become the data of the next row that have been inputted into the data channel. By means of accessing the linear buffer, the timing controller may read the buffered data voltage of the current row, that is, the first voltage; and the timing controller may further receive the video data sent by a Graphics Processing Unit (GPU) in the Graphics card; and then by means of parsing and extracting the video data, the data voltage of the next row is obtained, that is, the second voltage. When each of the switch devices is closed, charge transfer is performed on data charge in each data channel in the same channel group due to the voltage difference between the data channels, and finally the data voltage in each of the data channels in the same channel group is the same. That is to say, when each switch device is closed, the data charge of each of the data channels in the same channel group is averaged. In this embodiment, the first voltage of each data channel in the same channel group is averaged, a voltage value, that is the third voltage, in each data channel when the switch device is closed may be accurately predicted. In this embodiment, it is ensured that the data of the first voltage, the second voltage and the third voltage are accurately and simply acquired, such that accurate data support is provided for the execution of the subsequent determination step and the first control step.
step S102, a determination step: according to each of the plurality of the first voltages, each of the plurality of the second voltages corresponding to the plurality of the first voltages and each of the plurality of the third voltages corresponding to the plurality of the first voltages, it is determined, in a case that data of the next row are sent to the data channel after each the switch device is closed, that whether at least one of following is met: whether a first power-saving quantity being greater than a first predetermined threshold, whether a second power-saving quantity being greater than a second predetermined threshold, and the first power-saving quantity is a power-saving quantity of the source driver, and the second power-saving quantity is a sum of power-saving quantities of all of source drivers;

The determination step includes three situations. In the first situation, according to each first voltage, each corresponding second voltage and the corresponding third voltage, it is determined, if the data of the next row are sent to the data channel after each switch device is closed, whether the corresponding first power-saving quantity is greater than the first predetermined threshold, that is, whether the power-saving quantity of the source driver meets the requirement of being greater than the first predetermined threshold. In the second situation, there are a plurality of the source drivers, and the plurality of the source drivers form a source driving system; according to each first voltage, each corresponding second voltage and the corresponding third voltage, it is determined, if the data of the next row are sent to the data channel after each switch device is closed, whether the corresponding second power-saving quantity is greater than the second predetermined threshold, that is, whether the sum of the power-saving quantities of all of the source drivers meets the requirement of being greater than the second predetermined threshold. In the third situation, there are a plurality of source drivers; and according to each first voltage, each corresponding second voltage and the corresponding third voltage, it is determined, if the data of the next row are sent to the data channel after each switch device is closed, whether the corresponding first power-saving quantity is greater than the first predetermined threshold, and whether the second power-saving quantity is greater than the second predetermined threshold. In this step, it is assumed that the data of the next row are sent to the corresponding data channel after each switch device is closed, at least one of the following under this situation is calculated: the power-saving quantity of the source driver, the power-saving quantity of the entire source driving system, such that whether the switch device is closed before the data of the next row are sent to the data channel is conveniently subsequently determined according to a calculation result, and therefore, It is further realized that in the process of sending the data of the next row to the source driver, the power consumption of the source driver is relatively low, thereby further achieving the power-saving effect of the source driver.

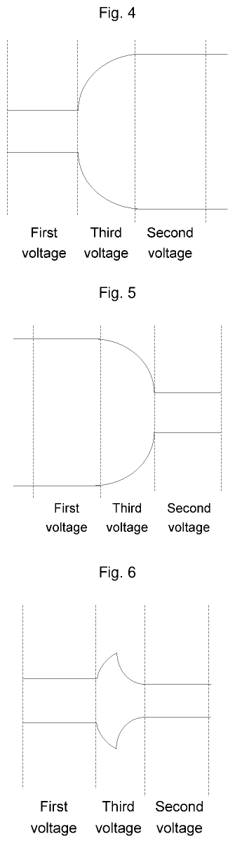

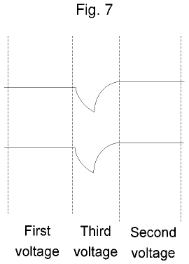

In some embodiments, according to each of the plurality of the first voltages, each of the plurality of the second voltages corresponding to the plurality of the first voltages and each of the plurality of the third voltages corresponding to the plurality of the first voltages, in the case that the data of the next row are sent to the data channel after each the switch device is closed, determining whether the first power-saving quantity is greater than the first predetermined threshold includes the following steps:
step S301, according to the first voltage, the second voltage corresponding to the first voltage and the third voltage corresponding to the first voltage, it is determined, in the case that the data of the next row are sent to the data channel after each the switch device is closed, whether the data channel is power-saving, and a voltage-saving quantity of the data channel; in a case that the data channel is power-saving, it is determined that the voltage-saving quantity is a positive number; and in a case that the data channel is not power-saving, it is determined that the voltage-saving quantity is a negative number;
After the first voltage, the corresponding second voltage and the third voltage are acquired, in the case that the data of the next row are sent to the data channel after each the switch device is closed, whether data channel is power-saving needs to be determined according to these acquired voltage data. The specific determination process includes the following steps:
step S401, as shown in FIG. 4 and FIG. 5, in a case that the first voltage, the third voltage and the second voltage are increased or decreased in order, it is determined, in the case that the data of the next row are sent to the data channel after each the switch device is closed, that the data channel is power-saving;
step S402, as shown in FIG. 6 and FIG. 7, in a case that the third voltage is separately greater than or less than the first voltage and the second voltage, that is, in the case that the third voltage is greater than the first voltage and the second voltage, or the third voltage is less than the first voltage and the second voltage, it is determined, in the case that the data of the next row are sent to the data channel after each the switch device is closed, that the data channel is not power-saving.

In addition, after the first voltage, the corresponding second voltage and the third voltage are acquired, in the case that the data of the next row are sent to the data channel after each the switch device is closed, the voltage-saving quantity of the data channel needs to be further determined. The process of determining the voltage-saving quantity of the data channel specifically includes the following steps:
step S501, in a case that the data channel is power-saving, it is determined that the voltage-saving quantity is an absolute value of a difference between the first voltage and the third voltage;
step S502, in a case that the data channel is not power-saving and both the second voltage and the third voltage are greater than or less than the first voltage, it is determined that the voltage-saving quantity is a negative number of the absolute value of the difference between the first voltage and the third voltage.
step S503, in a case that the data channel is not power-saving and both the second voltage and the third voltage are not greater than or less than the first voltage, it is determined that the voltage-saving quantity is a negative number of an absolute value of a difference between the second voltage and the third voltage.

After the determining result of whether the data channel is power-saving, and the voltage-saving quantity of the data channel are obtained, the following steps also need to be executed to determine whether the first power-saving quantity meets a preset requirement:
step S302, each of voltage-saving quantities corresponding to the source driver are added, so as to obtain the first power-saving quantity;
step S303, it is determined whether the first power-saving quantity is greater than the first predetermined threshold.

After the determining result of whether the data channel is power-saving, and the voltage-saving quantity of the data channel are obtained, the voltage-saving quantities corresponding to the source driver only need to be added, so as to obtain the first power-saving quantity; and then the first power-saving quantity is compared with the first predetermined threshold, so as to determine whether the first power-saving quantity is greater than the first predetermined threshold. In this way, it may be simply and quickly determined whether the source driver meets a charge sharing requirement. When the first power-saving quantity is greater than the first predetermined threshold, it indicates that the source driver meets the charge sharing requirement, and in this case, by means of closing the switch devices of the source driver and then sending the data of the next row to each corresponding data channel, the power-saving effect of the source driver during the inputting of the data of the next row into the source driver may be achieved.

The above steps are not only applicable to the case that there is only one source driver, but also applicable to the case that there are a plurality of source drivers. In the case that there are the plurality of the source drivers, by means of controlling the switch devices of the source driver of which first power-saving quantity is greater than the first predetermined threshold to be closed, and controlling other switch devices of the source driver that do not meet the above requirement to keep disconnected, the power consumption of the source driver is further reduced, thereby further guaranteeing lower power consumption of the entire system, and achieving the effect of saving energy and power.

The first predetermined threshold is a value greater than or equal to 0. The value may be determined according to experience, or may be acquired by means of experiments, and may be flexibly set by those skilled in the art.

In some embodiments, examples are used to describe a specific calculation process for a power-saving case and a power-consuming case. The unit of the following voltage values is volt. For ease of description, voltage units are not added after each piece of data. In a case of VH (that is, positive polarity), if the voltage of the sub-pixel data of the current row is 64, the voltage of the sub-pixel data of the next row is 128, and the voltage of the pixel data after charge sharing is performed by the method of the present disclosure is 100, belonging to the power-saving case, and power-saving quantity=100−64. In the case of VH, if the voltage of the sub-pixel data of the current row is 64, the voltage of the sub-pixel data of the next row is 128, and the voltage of the pixel data after charge sharing is 50, belonging to a power-wasting case, and power-wasting quantity=64−50. In the case of VH, if the voltage of the sub-pixel data of the current row is 64, the voltage of the sub-pixel data of the next row is 128, and the voltage of the pixel data after charge sharing is 150, belonging to the power-saving case, and power-saving quantity=128−64. In the case of VH, if the voltage of the sub-pixel data of the current row is 128, the voltage of the sub-pixel data of the next row is 64, and the voltage of the pixel data after charge sharing is 100, belonging to a discharge phase, such that it is neither power-saving, nor power-wasting. In the case of VH, if the voltage of the sub-pixel data of the previous row is 128, the voltage of the sub-pixel data of the current row is 64, and the voltage of the pixel data after charge sharing is 50, belonging to the power-wasting case, and power-wasting quantity=64−50. In the case of VH, if the voltage of the sub-pixel data of the current row is 128, the voltage of the sub-pixel data of the next row is 64, and the voltage of the pixel data after charge sharing is 150, belonging to the discharge phase, such that it is neither power-saving, nor power-wasting. In a case of VL (that is, negative polarity), if the voltage of the sub-pixel data of the previous row is 64, the voltage of the sub-pixel data of the current row is 128, and the voltage of the pixel data after charge sharing is 100, belonging to the discharge phase, such that it is neither power-saving, nor power-wasting. In the case of VL, if the voltage of the sub-pixel data of the previous row is 64, the voltage of the sub-pixel data of the current row is 128, and the voltage of the pixel data after charge sharing is 50, belonging to the discharge phase, such that it is neither power-saving, nor power-wasting. In the case of VL, if the voltage of the sub-pixel data of the previous row is 64, the voltage of the sub-pixel data of the current row is 128, and the voltage of the pixel data after charge sharing is 150, belonging to the power-wasting case, and power-wasting quantity=150−128. In the case of VL, if the voltage of the sub-pixel data of the current row is 128, the voltage of the sub-pixel data of the next row is 64, and the voltage of the pixel data after charge sharing is 100, belonging to the power-saving case, and power-saving quantity=128−100. In the case of VL, if the voltage of the sub-pixel data of the current row is 128, the voltage of the sub-pixel data of the next row is 64, and the voltage of the pixel data after charge sharing is 50, belonging to the power-saving case, and power-saving quantity=128−64. If the voltage of the sub-pixel data of the previous row is 128, the voltage of the sub-pixel data of the current row is 64, and the voltage of the pixel data after charge sharing is 150, belonging to a power-consuming case, and power-consuming quantity=150−128.

In the actual application, there are a plurality of the source drivers, and the plurality of the source drivers are arranged by at least one of following way: vertically, horizontally. According to each of the plurality of the first voltages, each of the plurality of the second voltages corresponding to the plurality of the first voltages and each of the plurality of the third voltages corresponding to the plurality of the first voltages, determining, in the case that the data of the next row are sent to the data channel after each the switch device is closed, whether the second power-saving quantity is greater than the second predetermined threshold is specifically introduced as follows:
step S601, each the first power-saving quantity is determined according to each of the plurality of the first voltages, each of the plurality of the second voltages corresponding to the plurality of the first voltages and each of the plurality of the third voltages corresponding to the plurality of the first voltages; this process may be obtained by means of calculation through step S301-S302, S401-S402 and S501-S503, which is not described herein again;
step S602, first power-saving quantities are added, so as to obtain the second power-saving quantity, and whether the second power-saving quantity is greater than the second predetermined threshold is determined.

By means of step S601 and S602, whether a source driving system meets the charge sharing requirement may be simply and quickly determined, that is, whether the second power-saving quantity is greater than the second predetermined threshold is determined. When the second power-saving quantity is greater than the second predetermined threshold, it indicates that the entire source driving system meets the charge sharing requirement, and in this case, by means of closing the switch devices of all of the source drivers and then sending the data of the next row to each corresponding data channel, the power-saving effect of the source driving system during the inputting of the data of the next row into the source driving system may be achieved.

The second predetermined threshold is a value greater than or equal to 0. The value may be determined according to experience, or may be acquired by means of experiments, and may be flexibly set by those skilled in the art.
step S103, a first control step: in a case that at least one of following is met: the first power-saving quantity being greater than the first predetermined threshold, the second power-saving quantity being greater than the second predetermined threshold, each the switch device of a target source driver is controlled to be closed, and then the data of the next row are sent to each of the plurality of the data channels corresponding to the data of the next row, and the target source driver is the source driver whose the first power-saving quantity is greater than the first preset threshold, or the target source driver is all of the source drivers.

In some embodiments, the first control step specifically includes the following:
In the case that the first power-saving quantity is greater than the first predetermined threshold, each the switch device of the source driver of which first power-saving quantity is greater than the first predetermined threshold is controlled to be closed, and then the data of the next row are sent to each corresponding data channel;
alternatively, in the case that the second power-saving quantity is greater than the second predetermined threshold, the switch devices of all of the source drivers are controlled to be closed, and then the data of the next row are sent to each corresponding data channel;
alternatively, in the case that first power-saving quantity is greater than the first predetermined threshold, and the second power-saving quantity is greater than the second predetermined threshold, the switch devices of all of the source drivers are controlled to be closed, and then the data of the next row are sent to each corresponding data channel.

According to another specific embodiment of the present disclosure, the source driver further includes a control module, the process of controlling each the switch device of the target source driver to be closed includes: a data packet is generated, and the data packet is sent to the control module of the target source driver, and the data packet is used for instructing the control module of the target source driver to close each the switch device. When at least one of the following is met: the first power-saving quantity is greater than the first predetermined threshold, the second power-saving quantity is greater than the second predetermined threshold, the corresponding switch devices are controlled to be closed by means of generating the data packet instructing the control module of the source driver to close the switch device thereof, and sending the data packet to the corresponding source driver.

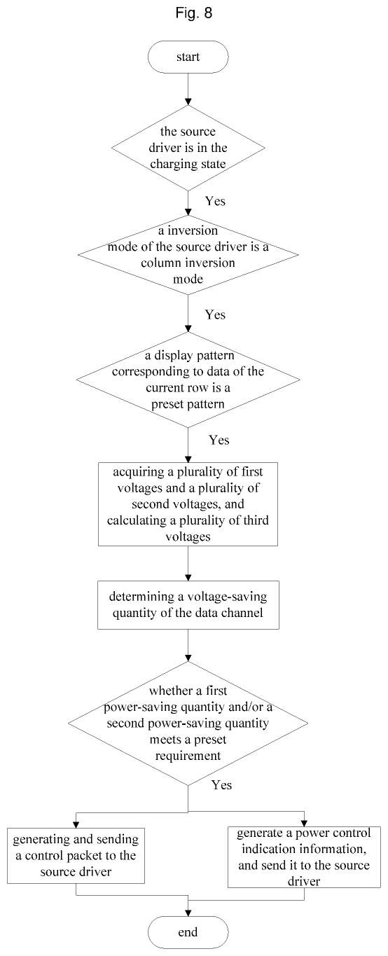

In this embodiment, in the case that at least one of the following is met: the first power-saving quantity is greater than the first predetermined threshold, the second power-saving quantity is greater than the second predetermined threshold, the method further includes: a power control indication information is generated, and the power control indication information is sent to the target source driver, to regulate and control parameters of the target source driver such as power, so as to cause the regulated and controlled data channels of the target source driver to normally receive the data of the next row. The flowchart of the method is shown in FIG. 8.

In addition, in a case that the first power-saving quantity is less than or equal to the first predetermined threshold, or the second power-saving quantity is less than or equal to the second predetermined threshold, the method further includes the following step:
step S104, a second control step: each the switch device of the target source driver are controlled to turn off, and then sending the data of the next row to each of the plurality of the data channels corresponding to the data of the next row.

When the first power-saving quantity is less than or equal to the first predetermined threshold, or the second power-saving quantity is less than or equal to the second predetermined threshold, by means of the second control step, the problem of power consumption of the source driver caused by some of the switch devices being in the closed state is avoided.

During the actual application, in order to further prevent the switch devices from being switched on and off by mistake to cause wasting of the power of the source driver, in an embodiment of the present disclosure, an initial state of each the switch device of the source driver is set to be a disconnected state.

A display pattern of a display is generally formed by a plurality of rows of video stream data, the process in this embodiment of the present disclosure is a process of processing one row of the video stream data. In order to further ensure the low power consumption of the source driver in an overall charging process, an embodiment of the present disclosure further includes the following step:
step S105, the acquisition step, the determination step, and the first control step or the second control step are successively executed for at least once, until all row data of video data are sent to the plurality of the data channels corresponding to the data of the next row.

Considering the inaccuracy of the virtual data in the row data, it may lead to incorrect calculation of power-saving quantities, in the present disclosure, some shielding logic is added to shield the virtual data of some abnormal positions. Specifically, up to 8 positions may be shielded for each data channel. The maximum 1 to 7 masks may be set for a maximum increment value or the maximum increment value divided by 2/4/8/16. However, the setting is for each of the source drivers.

It is to be noted that the steps shown in the flow diagram of the accompanying drawings may be executed in a computer system, such as a set of computer-executable instructions, and although a logical sequence is shown in the flow diagram, in some cases, the steps shown or described may be executed in a different order than here.

An embodiment of the present disclosure further provides an apparatus for controlling a source driver. There is at least one source driver to be controlled. The source driver includes a plurality of channel groups, the channel group includes a plurality of data channels with same polarity which are arranged in order, and any two of the plurality of the data channels in the channel group are connected by means of a switch device. The above expression of being arranged in order may be represented to be arranged according to columns, or be arranged according to rows.

In an actual application, as shown in FIG. 1, in the source driver, the data channels are arranged according to a column sequence (that is, in a vertical direction), and the data channels with positive and negative polarity are arranged alternately. That is to say, both two adjacent sides of the data channel with positive polarity are the data channels with negative polarity. In the channel group, the plurality of adjacent data channels with the same polarity are connected by means of switch devices. The number of the data channels connected may be flexibly set according to actual requirements. For example, 3 data channels are connected as a group used as the channel group, 4 data channels are connected as a group used as the channel group, and so on. FIG. 3 shows an example of 3 data channels connected as a group used as the channel group.

By means of the technical solutions of the present disclosure, in the method for controlling the source driver, firstly, when the source driver is in the charging state, the plurality of the first voltages and the plurality of the second voltages are acquired, and the plurality of the third voltages are calculated, and the first voltage is the data voltage of the current row of the data channel, the second voltage is the data voltage of the next row of the current row of the data channel, and the third voltage is the data voltage of the current row of the data channel when each of the switch devices is closed; then, according to the acquired first voltage, the second voltage and the third voltage, when the data of the next row are sent to the data channel after each of the switch devices is closed, whether at least one of the following is met is determined: whether a power-saving requirement of the single source driver is met, whether power-saving requirements of all of the source drivers are met; and finally, when the power-saving requirements are met, charge sharing control is executed, that is, each of the switch devices of the target source driver is controlled to be closed, and then the data of the next row are sent to each of the corresponding data channels. In the present disclosure, by means of the plurality of the first voltages, the second voltages and the third voltages, when each of the switch devices is opened, at least one of the following is determined: whether the power-saving quantity of the source driver is greater than the predetermined threshold, the power-saving quantities of all of the source drivers are greater than the predetermined threshold; and if the power-saving quantity is greater than the predetermined threshold, the switch of the source driver is controlled to be closed, so as to perform charge sharing on the data channels in each of the channel groups, and the data of the next row are sent to each of the data channels. In this way, the power of the source driver during charging is saved, such that the power consumption of the entire display can be reduced, and the problem in the prior art of high power consumption of the source driver during charging is effectively solved.

It is to be noted that, the apparatus for controlling the source driver in this embodiment of the present disclosure may be configured to execute the method for controlling the source driver provided in the embodiment of the present disclosure. The apparatus for controlling the source driver provided in this embodiment of the present disclosure is introduced below.

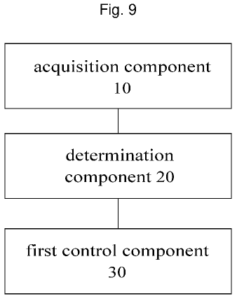

FIG. 9 is a schematic diagram of an apparatus for controlling a source driver according to an embodiment of the present disclosure. As shown in FIG. 9, the apparatus includes:
an acquisition component 10, configured to perform an acquisition step: in a case that the source driver is in a charging state, a plurality of first voltages and a plurality of second voltages are acquired, and a plurality of third voltages are calculated, and the first voltage is a data voltage of a current row of the data channel, the second voltage is a data voltage of a next row of the current row of the data channel, and the third voltage is a data voltage of the current row of the data channel in a case that each the switch device is closed;
The rows in the row data may be horizontal or vertical, and are perpendicular to an arrangement direction of the data channels. The data of the current row and the data of the next row are sub-pixel data.

The apparatus provided in this embodiment of the present disclosure may be applied to a timing controller. As shown in FIG. 1, the plurality of the data channels are correspondingly connected to linear buffers on a one-to-one base. The acquisition component includes:
a first determination module, configured to in a case that the source driver is in the charging state and a inversion mode of the source driver is a column inversion mode, determine whether a display pattern corresponding to data of the current row is a preset pattern, and the preset pattern is a pattern displayed by a preset display device;
a reading module, configured to in a case that the display pattern is the preset pattern, read the data voltage of the current row stored in each of the linear buffers, so as to obtain the plurality of the first voltages;
a receiving module, configured to receive video data, and extract the data voltage of the next row from the video data, so as to obtain the second voltage.
a calculation module, configured to calculate an average value of the plurality of the first voltages of each of the plurality of the data channels in the same channel group, so as to obtain the third voltage corresponding to each of the plurality of the data channels.

When the source driver is in the charging state and the inversion mode thereof is column inversion (which may also be called row inversion), the display pattern corresponding to the data of the current row is further required to be determined, that is, whether the display pattern of the display is the preset pattern; and if the display pattern is the preset pattern, subsequent actions of data acquisition, power-saving quantity calculation and charge sharing control are executed. That is to say, in the present disclosure, the charging sharing control of the source driver is combined with a special pattern, that is, when the special pattern is displayed and the power-saving quantity meets requirements, charging sharing control is performed on the source driver. In this way, the charge quantity of the source driver during charging may be effectively reduced, thereby guaranteeing low power consumption of the entire display device.

The preset pattern may be another pattern other than black, white and gray patterns, for example, red, green and blue patterns, stripe patterns shown in FIG. 3, checkerboard patterns, or the like. Definitely, the preset pattern is not limited to the above patterns. Those skilled in the art may flexibly design any display pattern as the preset pattern according to the requirements of chip manufacturers. Generally, the designed preset pattern is a pattern that has high power consumption during scanning and display.

It is to be noted that, the control apparatus of the present disclosure is not applicable to the control of the source driver of which inversion mode is dot inversion mode. In addition, a power-saving or non-power-saving situation is calculated only at a charging phase, and inspection is not required at a discharging state. In short, when the power consumption of charge sharing is calculated, only a rising situation is summarized. As a falling situation is only a discharging situation, when the source driver is in a discharging state or the inversion mode of the source driver is dot inversion mode, the timing controller transmits, according to an existing processing mode, the data of each row to the data channel corresponding to the source driver. The data of the current row is the video data which have currently been inputted into the data channel, and the data of the next row is the data that are adjacent to the current row, have not yet been inputted and to be inputted to the data channel.

The linear buffer is used for buffering the data of the current row that have been inputted into the data channel; and after the data of the next row are inputted into the data channel, the data buffered in the linear buffer become the data of the next row that have been inputted into the data channel. By means of accessing the linear buffer, the timing controller may read the buffered data voltage of the current row, that is, the first voltage; and the timing controller may further receive the video data sent by a GPU in the Graphics card; and then by means of parsing and extracting the video data, the data voltage of the next row is obtained, that is, the second voltage. When each of the switch devices is closed, charge transfer is performed on data charge in each data channel in the same channel group due to the voltage difference between the data channels, and finally the data voltage in each of the data channels in the same channel group is the same. That is to say, when each switch device is closed, the data charge of each of the data channels in the same channel group is averaged. In this embodiment, the first voltage of each data channel in the same channel group is averaged, a voltage value, that is the third voltage, in each data channel when the switch device is closed may be accurately predicted. In this embodiment, it is ensured that the data of the first voltage, the second voltage and the third voltage are accurately and simply acquired, such that accurate data support is provided for the execution of the subsequent determination step and the first control step.
a determination component 20, configured to perform a determination step: according to each of the plurality of the first voltages, each of the plurality of the second voltages corresponding to the plurality of the first voltages and each of the plurality of the third voltages corresponding to the plurality of the first voltages, it is determined, in a case that data of the next row are sent to the data channel after each the switch device is closed, that whether at least one of following is met: whether a first power-saving quantity being greater than a first predetermined threshold, whether a second power-saving quantity being greater than a second predetermined threshold, and the first power-saving quantity is a power-saving quantity of the source driver, and the second power-saving quantity is a sum of power-saving quantities of all of source drivers.

The determination step includes three situations. In the first situation, according to each first voltage, each corresponding second voltage and the corresponding third voltage, it is determined, if the data of the next row are sent to the data channel after each switch device is closed, whether the corresponding first power-saving quantity is greater than the first predetermined threshold, that is, whether the power-saving quantity of the source driver meets the requirement of being greater than the first predetermined threshold. In the second situation, there are a plurality of the source drivers, and the plurality of the source drivers form a source driving system; according to each first voltage, each corresponding second voltage and the corresponding third voltage, it is determined, if the data of the next row are sent to the data channel after each switch device is closed, whether the corresponding second power-saving quantity is greater than the second predetermined threshold, that is, whether the sum of the power-saving quantities of all of the source drivers meets the requirement of being greater than the second predetermined threshold. In the third situation, there are a plurality of source drivers; and according to each first voltage, each corresponding second voltage and the corresponding third voltage, it is determined, if the data of the next row are sent to the data channel after each switch device is closed, whether the corresponding first power-saving quantity is greater than the first predetermined threshold, and whether the second power-saving quantity is greater than the second predetermined threshold. In this step, it is assumed that the data of the next row are sent to the corresponding data channel after each switch device is closed, at least one of the following under this situation is calculated: the power-saving quantity of the source driver, the power-saving quantity of the entire source driving system, such that whether the switch device is closed before the data of the next row are sent to the data channel is conveniently subsequently determined according to a calculation result, and therefore, It is further realized that in the process of sending the data of the next row to the source driver, the power consumption of the source driver is relatively low, thereby further achieving the power-saving effect of the source driver.

In some embodiments, the determination component includes:
a second determination module, configured to, according to the first voltage, the second voltage corresponding to the first voltage and the third voltage corresponding to the first voltage, determine, in the case that the data of the next row are sent to the data channel after each the switch device is closed, whether the data channel is power-saving, and voltage-saving quantity of the data channel; in a case that the data channel is power-saving, determine that the voltage-saving quantity is a positive number, and in a case that the data channel is not power-saving, determine that the voltage-saving quantity is a negative number.

After the first voltage, the corresponding second voltage and the third voltage are acquired, in the case that the data of the next row are sent to the data channel after each the switch device is closed, whether data channel is power-saving needs to be determined according to these acquired voltage data. The second determination module includes:
a first determination sub-module, as shown in FIG. 4 and FIG. 5, configured to, in a case that the first voltage, the third voltage and the second voltage are increased or decreased in order, determine, in the case that the data of the next row are sent to the data channel after each the switch device is closed, that the data channel is power-saving;
a second determination sub-module, as shown in FIG. 6 and FIG. 7, configured to, in a case that the third voltage is separately greater than or less than the first voltage and the second voltage, that is, in the case that the third voltage is greater than the first voltage and the second voltage, or the third voltage is less than the first voltage and the second voltage, determine, in the case that the data of the next row are sent to the data channel after each the switch device is closed, that the data channel is not power-saving.

In addition, after the first voltage, the corresponding second voltage and the third voltage are acquired, in the case that the data of the next row are sent to the data channel after each the switch device is closed, the voltage-saving quantity of the data channel needs to be further determined. The second determination module further includes:
a third determination sub-module, configured to, in a case that the data channel is power-saving, determine that the voltage-saving quantity is an absolute value of a difference between the first voltage and the third voltage;
a fourth determination sub-module, configured to, in a case that the data channel is not power-saving and both the second voltage and the third voltage are greater than or less than the first voltage, determine that the voltage-saving quantity is a negative number of the absolute value of the difference between the first voltage and the third voltage;
a fifth determination sub-module, configured to, in a case that the data channel is not power-saving and both the second voltage and the third voltage are not greater than or less than the first voltage, determine that the voltage-saving quantity is a negative number of an absolute value of a difference between the second voltage and the third voltage.

After the determining result of whether the data channel is power-saving, and the voltage-saving quantity of the data channel are obtained, the determination component further includes:
a first addition module, configured to add each of voltage-saving quantities corresponding to the source driver, so as to obtain the first power-saving quantity;
a third determination module, configured to determine whether the first power-saving quantity is greater than the first predetermined threshold.

After the determining result of whether the data channel is power-saving, and the voltage-saving quantity of the data channel are obtained, the voltage-saving quantities corresponding to the source driver only need to be added, so as to obtain the first power-saving quantity; and then the first power-saving quantity is compared with the first predetermined threshold, so as to determine whether the first power-saving quantity is greater than the first predetermined threshold. In this way, it may be simply and quickly determined whether the source driver meets a charge sharing requirement. When the first power-saving quantity is greater than the first predetermined threshold, it indicates that the source driver meets the charge sharing requirement, and in this case, by means of closing the switch device of the source driver and then sending the data of the next row to each corresponding data channel, the power-saving effect of the source driver during the inputting of the data of the next row into the source driver may be achieved.

The above components and modules are not only applicable to the case that there is only one source driver, but also applicable to the case that there are a plurality of the source drivers. In the case that there are the plurality of source drivers, by means of controlling the switch device of the source driver of which first power-saving quantity is greater than the first predetermined threshold to be closed, and controlling other switch devices of the source driver that do not meet the above requirement to keep disconnected, the power consumption of the source driver is further reduced, thereby further guaranteeing lower power consumption of the entire system, and achieving the effect of saving energy and power.

The first predetermined threshold is a value greater than or equal to 0. The value may be determined according to experience, or may be acquired by means of experiments, and may be flexibly set by those skilled in the art.

In some embodiments, examples are used to describe a specific calculation process for a power-saving case and a power-consuming case. The unit of the following voltage values is volt. For ease of description, voltage units are not added after each piece of data. In a case of VH (that is, positive polarity), if the voltage of the sub-pixel data of the current row is 64, the voltage of the sub-pixel data of the next row is 128, and the voltage of the pixel data after charge sharing is performed by the apparatus of the present disclosure is 100, belonging to the power-saving case, and power-saving quantity=100−64. In the case of VH, if the voltage of the sub-pixel data of the current row is 64, the voltage of the sub-pixel data of the next row is 128, and the voltage of the pixel data after charge sharing is 50, belonging to a power-wasting case, and power-wasting quantity=64-50. In the case of VH, if the voltage of the sub-pixel data of the current row is 64, the voltage of the sub-pixel data of the next row is 128, and the voltage of the pixel data after charge sharing is 150, belonging to the power-saving case, and power-saving quantity=128−64. In the case of VH, if the voltage of the sub-pixel data of the current row is 128, the voltage of the sub-pixel data of the next row is 64, and the voltage of the pixel data after charge sharing is 100, belonging to a discharge phase, such that it is neither power-saving, nor power-wasting. In the case of VH, if the voltage of the sub-pixel data of the previous row is 128, the voltage of the sub-pixel data of the current row is 64, and the voltage of the pixel data after charge sharing is 50, belonging to the power-wasting case, and power-wasting quantity=64-50. In the case of VH, if the voltage of the sub-pixel data of the current row is 128, the voltage of the sub-pixel data of the next row is 64, and the voltage of the pixel data after charge sharing is 150, belonging to the discharge phase, such that it is neither power-saving, nor power-wasting. In a case of VL (that is, negative polarity), if the voltage of the sub-pixel data of the previous row is 64, the voltage of the sub-pixel data of the current row is 128, and the voltage of the pixel data after charge sharing is 100, belonging to the discharge phase, such that it is neither power-saving, nor power-wasting. In the case of VL, if the voltage of the sub-pixel data of the previous row is 64, the voltage of the sub-pixel data of the current row is 128, and the voltage of the pixel data after charge sharing is 50, belonging to the discharge phase, such that it is neither power-saving, nor power-wasting. In the case of VL, if the voltage of the sub-pixel data of the previous row is 64, the voltage of the sub-pixel data of the current row is 128, and the voltage of the pixel data after charge sharing is 150, belonging to the power-wasting case, and power-wasting quantity=150−128. In the case of VL, if the voltage of the sub-pixel data of the current row is 128, the voltage of the sub-pixel data of the next row is 64, and the voltage of the pixel data after charge sharing is 100, belonging to the power-saving case, and power-saving quantity=128−100. In the case of VL, if the voltage of the sub-pixel data of the current row is 128, the voltage of the sub-pixel data of the next row is 64, and the voltage of the pixel data after charge sharing is 50, belonging to the power-saving case, and power-saving quantity=128−64. If the voltage of the sub-pixel data of the previous row is 128, the voltage of the sub-pixel data of the current row is 64, and the voltage of the pixel data after charge sharing is 150, belonging to a power-consuming case, and power-consuming quantity=150−128.

In the actual application, there are a plurality of the source drivers, and the plurality of source drivers are arranged by at least one of following way: vertically, horizontally. The determination component further includes:
a fourth determination module, configured to each the first power-saving quantity according to each of the plurality of the first voltages, each of the plurality of the second voltages corresponding to the plurality of the first voltages and each of the plurality of the third voltages corresponding to the plurality of the first voltages; this process may be obtained by means of calculation through the second determination module, the first addition module, the first determination sub-module, the second determination sub-module, the third determination sub-module, the fourth determination sub-module and the fifth determination sub-module, which is not described herein again;
a second addition module, configured to add first power-saving quantities, so as to obtain the second power-saving quantity, and determine whether the second power-saving quantity is greater than the second predetermined threshold.

By means of the fourth determination module and the second addition module, whether a source driving system meets the charge sharing requirement may be simply and quickly determined, that is, whether the second power-saving quantity is greater than the second predetermined threshold is determined. When the second power-saving quantity is greater than the second predetermined threshold, it indicates that the entire source driving system meets the charge sharing requirement, and in this case, by means of closing the switch devices of all of the source drivers and then sending the data of the next row to each corresponding data channel, the power-saving effect of the source driving system during the inputting of the data of the next row into the source driving system may be achieved.

The second predetermined threshold is a value greater than or equal to 0. The value may be determined according to experience, or may be acquired by means of experiments, and may be flexibly set by those skilled in the art.
a first control component 30, configured to perform a first control step: in a case that at least one of following is met: the first power-saving quantity being greater than the first predetermined threshold, the second power-saving quantity being greater than the second predetermined threshold, each the switch device of a target source driver is controlled to be closed, and then the data of the next row are sent to each of the plurality of the data channels corresponding to the data of the next row, and the target source driver is the source driver whose the first power-saving quantity is greater than the first preset threshold, or the target source driver is all of the source drivers.

In some embodiments, the first control component includes:
a first control module, configured to, In the case that the first power-saving quantity is greater than the first predetermined threshold, control each the switch device of the source driver of which first power-saving quantity is greater than the first predetermined threshold to be closed, and then send the data of the next row to each corresponding data channel.
alternatively, a second control module, configured to, in the case that the second power-saving quantity is greater than the second predetermined threshold, control the switch devices of all of the source drivers to be closed, and then send the data of the next row to each corresponding data channel;
alternatively, a third control module, configured to, in the case that first power-saving quantity is greater than the first predetermined threshold, and the second power-saving quantity is greater than the second predetermined threshold, control the switch devices of all of the source drivers to be closed, and then send the data of the next row to each corresponding data channel.

According to another specific embodiment of the present disclosure, the source driver further includes a control module, the first control component further includes a generation module, configured to generate a data packet, and send the data packet to the control module of the target source driver, and the data packet is used for instructing the control module of the target source driver to close each the switch device. When at least one of the following is met: the first power-saving quantity is greater than the first predetermined threshold, the second power-saving quantity is greater than the second predetermined threshold, the corresponding switch devices are controlled to be closed by means of generating the data packet instructing the control module of the source driver to close the switch device thereof, and sending the data packet to the corresponding source driver.

In this embodiment, the apparatus further includes: a generation component, configured to, in the case that at least one of the following is met: the first power-saving quantity is greater than the first predetermined threshold, the second power-saving quantity is greater than the second predetermined threshold, generate a power control indication information, and send the power control indication information to the target source driver, to regulate and control parameters of the target source driver such as power, so as to cause the regulated and controlled data channels of the target source driver to normally receive the data of the next row. The flowchart is shown in FIG. 8.

In addition, the apparatus further includes:
a second determination component, configured to, in a case that the first power-saving quantity is less than or equal to the first predetermined threshold, or the second power-saving quantity is less than or equal to the second predetermined threshold, executing a second control step: each the switch device of the target source driver is controlled to turn off, and then the data of the next row are sent to each of the plurality of the data channels corresponding to the data of the next row.

When the first power-saving quantity is less than or equal to the first predetermined threshold, or the second power-saving quantity is less than or equal to the second predetermined threshold, by means of the second control step, the problem of power consumption of the source driver caused by some of the switch devices being in the closed state is avoided.

During the actual application, in order to further prevent the switch devices from being switched on and off by mistake to cause wasting of the power of the source driver, in an embodiment of the present disclosure, an initial state of each the switch device of the source driver is set to be a disconnected state.

A display pattern of a display is generally formed by a plurality of rows of video stream data, the process in this embodiment of the present disclosure is a process of processing one row of the video stream data. In order to further ensure the low power consumption of the source driver in an overall charging process, in an embodiment of the present disclosure, the apparatus further includes:
a circulation component, configured to successively execute the acquisition step, the determination step, and the first control step or the second control step for at least once, until all row data of the video data are sent to the corresponding data channels.

Considering the inaccuracy of the virtual data in the row data, it may lead to incorrect calculation of power-saving quantities, in the present disclosure, some shielding logic is added to shield the virtual data of some abnormal positions. Specifically, up to 8 positions may be shielded for each data channel. The maximum 1 to 7 masks may be set for a maximum increment value or the maximum increment value divided by 2/4/8/16. However, the setting is for each of the source drivers.

In the apparatus for controlling the source driver in the embodiment of the present disclosure, by means of the acquisition component, when the source driver is in the charging state, the plurality of the first voltages and the plurality of the second voltages are acquired, and the plurality of the third voltages are calculated, and the first voltage is the data voltage of the current row of the data channel, the second voltage is the data voltage of the next row of the current row of the data channel, and the third voltage is the data voltage of the current row of the data channel when each of the switch devices is closed; by means of the determination component, according to the acquired first voltage, the second voltage and the third voltage, when the data of the next row are sent to the data channel after each of the switch devices is closed, whether at least one of the following is met is determined: whether a power-saving requirement of the single source driver is met is determined, whether the power-saving requirements of all of the source drivers are met; and by means of the first control component, when the power-saving requirements are met, charge sharing control is executed, that is, each switch device of the target source driver is controlled to be closed, and then the data of the next row are sent to each of the corresponding data channels. In the present disclosure, by means of the plurality of the first voltages, the second voltages and the third voltages, when each of the switch devices is opened, at least one of the following is determined: whether the power-saving quantity of the source driver is greater than the predetermined threshold, the power-saving quantities of all of the source drivers are greater than the predetermined threshold; and if the power-saving quantity is greater than the predetermined threshold, the switch of the source driver is controlled to be closed, so as to perform charge sharing on the data channels in each of the channel groups, and the data of the next row are sent to each of the data channels. In this way, the power of the source driver during charging is saved, such that the power consumption of the entire display can be reduced, and the problem in the prior art of high power consumption of the source driver during charging is effectively solved.

The apparatus for controlling the source driver includes a processor and a memory. The acquisition component, the determination component and the first control component are all stored in the memory as program components. The processor executes the program components stored in the memory to implement corresponding functions.

The processor includes a kernel, and the kernel invokes the corresponding program components from the memory. There may be one or more kernels arranged. The problem in the prior art of high power consumption of the source driver during charging is solved by adjusting kernel parameters.

The memory may include a non-persistent memory in a computer-readable medium, a Random Access Memory (RAM) and/or a non-volatile memory, for example, a Read Only Memory (ROM) or a flash memory (flash RAM). The memory includes at least one memory chip.

An embodiment of the present disclosure provides a computer-readable storage medium. The computer-readable storage medium stores a program. The method for controlling the source driver is implemented when the program is executed by a processor.

An embodiment of the present disclosure provides a processor. The processor is configured to operate a program. The method for controlling the source driver is executed when the program is operated.

An embodiment of the present disclosure provides a device. The device includes a processor, a memory, and a program stored on the memory and executable on the processor. The processor, when executing the program, implements at least the following steps:
step S101, an acquisition step: in a case that the source driver is in a charging state, a plurality of first voltages and a plurality of second voltages are acquired, and a plurality of third voltages are calculated, and the first voltage is a data voltage of a current row of the data channel, the second voltage is a data voltage of a next row of the current row of the data channel, and the third voltage is a data voltage of the current row of the data channel in a case that each the switch device is closed;
step S102, a determination step: according to each of the plurality of the first voltages, each of the plurality of the second voltages corresponding to the plurality of the first voltages and each of the plurality of the third voltages corresponding to the plurality of the first voltages, it is determined, in a case that data of the next row are sent to the data channel after each the switch device is closed, that whether at least one of following is met: whether a first power-saving quantity being greater than a first predetermined threshold, whether a second power-saving quantity being greater than a second predetermined threshold, and the first power-saving quantity is a power-saving quantity of the source driver, and the second power-saving quantity is a sum of power-saving quantities of all of source drivers;
step S103, a first control step: in a case that at least one of following is met: the first power-saving quantity being greater than the first predetermined threshold, the second power-saving quantity being greater than the second predetermined threshold, each the switch device of a target source driver is controlled to be closed, and then the data of the next row are sent to each of the plurality of the data channels corresponding to the data of the next row, and the target source driver is the source driver whose the first power-saving quantity is greater than the first preset threshold, or the target source driver is all of the source drivers.

The device herein may be a server, a PC, a PAD, a mobile phone, or the like.

The present disclosure further provides a computer program product. When being executed on a data processing device, the computer program product is adapted to execute a program initialized with at least the following method steps:
step S101, an acquisition step: in a case that the source driver is in a charging state, a plurality of first voltages and a plurality of second voltages are acquired, and a plurality of third voltages are calculated, and the first voltage is a data voltage of a current row of the data channel, the second voltage is a data voltage of a next row of the current row of the data channel, and the third voltage is a data voltage of the current row of the data channel in a case that each the switch device is closed;
step S102, a determination step: according to each of the plurality of the first voltages, each of the plurality of the second voltages corresponding to the plurality of the first voltages and each of the plurality of the third voltages corresponding to the plurality of the first voltages, it is determined, in a case that data of the next row are sent to the data channel after each the switch device is closed, that whether at least one of following is met: whether a first power-saving quantity being greater than a first predetermined threshold, whether a second power-saving quantity being greater than a second predetermined threshold, and the first power-saving quantity is a power-saving quantity of the source driver, and the second power-saving quantity is a sum of power-saving quantities of all of source drivers;
step S103, a first control step: in a case that at least one of following is met: the first power-saving quantity being greater than the first predetermined threshold, the second power-saving quantity being greater than the second predetermined threshold, each the switch device of a target source driver is controlled to be closed, and then the data of the next row are sent to each of the plurality of the data channels corresponding to the data of the next row, and the target source driver is the source driver whose the first power-saving quantity is greater than the first preset threshold, or the target source driver is all of the source drivers.

Still another aspect of the embodiment of the present disclosure further provides a timing controller. The timing controller includes one or more processors, a memory, and one or more programs. The one or more programs are stored in the memory, and are configured to be executed by the one or more processors. The one or more programs include instructions that are used for executing any one of the methods described.

The timing controller is configured to execute any one of the above methods. In the method, by means of the plurality of the first voltages, the second voltages and the third voltages, when each of the switch devices is opened, at least one of the following is determined: whether the power-saving quantity of the source driver is greater than the predetermined threshold, the power-saving quantities of all of the source drivers are greater than the predetermined threshold; and if the power-saving quantity is greater than the predetermined threshold, the switch of the source driver is controlled to be closed, so as to perform charge sharing on the data channels in each of the channel groups, and the data of the next row are sent to each of the data channels. In this way, the power of the source driver during charging is saved, such that the power consumption of the entire display can be reduced, and the problem in the prior art of high power consumption of the source driver during charging is effectively solved.

Another typical embodiment of the present disclosure further provides a display system. The display system includes a display device, at least one source driver and the timing controller. An output of the source driver is connected to the display device. The source driver includes a plurality of channel groups, the channel group includes a plurality of data channels with the same polarity which are arranged in order, and any two of the plurality of the data channels in the channel group are connected by means of a switch device; and the timing controller is connected to an input of the source driver.

The display system includes a display device, a source driver and a timing controller. The timing controller is configured to execute any one of the above methods, so as to control the source driver. In the method, by means of the plurality of the first voltages, the second voltages and the third voltages, when each of the switch devices is opened, at least one of the following is determined: whether the power-saving quantity of the source driver is greater than the predetermined threshold, the power-saving quantities of all of the source drivers are greater than the predetermined threshold; and if the power-saving quantity is greater than the predetermined threshold, the switch of the source driver is controlled to be closed, so as to perform charge sharing on the data channels in each of the channel groups, and the data of the next row are sent to each of the data channels. In this way, the power of the source driver during charging is saved, such that the power consumption of the entire display can be reduced, and the problem in the prior art of high power consumption of the source driver during charging is effectively solved.

Taking into account the cost of hardware improvements to the source driver, the control cost of the timing controller and the ultimate power-saving quantities, three adjacent data channels with the same polarity are connected as a channel group, that is, each channel group has three data channels.

In the above embodiments of the present disclosure, the description of the embodiments has its own focus. For parts that are not described in detail in a certain embodiment, reference may be made to related descriptions of other embodiments.

In the several embodiments provided in the present disclosure, it should be understood that, the disclosed technical content can be implemented in other ways. The apparatus embodiments described above are merely illustrative. For example, the division of the components may be a logical function division, and there may be other divisions in actual implementation. For example, a plurality of components or components may be combined or integrated into another system, or some features can be ignored, or not implemented. In addition, the displayed or discussed mutual coupling or direct coupling or communication connection may be indirect coupling or communication connection through some interfaces, components or modules, and may be in electrical or other forms.

The components described as separate components may or may not be physically separated. The components displayed as components may or may not be physical components, that is, the components may be located in one place, or may be distributed on the plurality of components. Part or all of the components may be selected according to actual requirements to achieve the purposes of the solutions of this embodiment.

In addition, the functional components in the various embodiments of the present disclosure may be integrated into one processing component, or each component may exist alone physically, or two or more than two components may be integrated into one component. The above integrated component can be implemented in the form of hardware, or can be implemented in the form of a software functional component.

If the integrated component is implemented in the form of the software functional component and sold or used as an independent product, it can be stored in the computer readable storage medium. Based on this understanding, the technical solutions of the present disclosure essentially or the parts that contribute to the prior art, or all or part of the technical solutions can be embodied in the form of a software product. The computer software product is stored in a storage medium, including a plurality of instructions for causing a computer device (which may be a personal computer, a server, or a network device, and the like) to execute all or part of the steps of the method described in the various embodiments of the present disclosure. The foregoing storage medium includes a USB flash disk, a Read-Only Memory (ROM), a Random Access Memory (RAM), and various media that can store program codes, such as a mobile hard disk, a magnetic disk, or an optical disk.

It may be seen from the above description that, in the above embodiments of the present disclosure, the following technical effects are realized.
1) In the method for controlling the source driver, firstly, when the source driver is in the charging state, the plurality of the first voltages and the plurality of the second voltages are acquired, and the plurality of the third voltages are calculated, and the first voltage is the data voltage of the current row of the data channel, the second voltage is the data voltage of the next row of the current row of the data channel, and the third voltage is the data voltage of the current row of the data channel when each of the switch devices is closed; then, according to the acquired first voltage, the second voltage and the third voltage, when the data of the next row are sent to the data channel after each of the switch devices is closed, whether at least one of the following is met is determined: whether a power-saving requirement of the single source driver is met, whether power-saving requirements of all of the source drivers are met; and finally, when the power-saving requirements are met, charge sharing control is executed, that is, each of the switch devices of the target source driver is controlled to be closed, and then the data of the next row are sent to each of the corresponding data channels. In the present disclosure, by means of the plurality of the first voltages, the second voltages and the third voltages, when each of the switch devices is opened, at least one of the following is determined: whether the power-saving quantity of the source driver is greater than the predetermined threshold, the power-saving quantities of all of the source drivers are greater than the predetermined threshold; and if the power-saving quantity is greater than the predetermined threshold, the switch of the source driver is controlled to be closed, so as to perform charge sharing on the data channels in each of the channel groups, and the data of the next row are sent to each of the data channels. In this way, the power of the source driver during charging is saved, such that the power consumption of the entire display can be reduced, and the problem in the prior art of high power consumption of the source driver during charging is effectively solved.
2) In the apparatus for controlling the source driver, by means of the acquisition component, when the source driver is in the charging state, the plurality of the first voltages and the plurality of the second voltages are acquired, and the plurality of the third voltages are calculated, and the first voltage is the data voltage of the current row of the data channel, the second voltage is the data voltage of the next row of the current row of the data channel, and the third voltage is the data voltage of the current row of the data channel when each of the switch devices is closed; by means of the determination component, according to the acquired first voltage, the second voltage and the third voltage, when the data of the next row are sent to the data channel after each of the switch devices is closed, whether at least one of the following is met is determined: whether a power-saving requirement of the single source driver is met is determined, whether the power-saving requirements of all of the source drivers are met; and by means of the first control component, when the power-saving requirements are met, charge sharing control is executed, that is, each switch device of the target source driver is controlled to be closed, and then the data of the next row are sent to each of the corresponding data channels. In the present disclosure, by means of the plurality of the first voltages, the second voltages and the third voltages, when each of the switch devices is opened, at least one of the following is determined: whether the power-saving quantity of the source driver is greater than the predetermined threshold, the power-saving quantities of all of the source drivers are greater than the predetermined threshold; and if the power-saving quantity is greater than the predetermined threshold, the switch of the source driver is controlled to be closed, so as to perform charge sharing on the data channels in each of the channel groups, and the data of the next row are sent to each of the data channels. In this way, the power of the source driver during charging is saved, such that the power consumption of the entire display can be reduced, and the problem in the prior art of high power consumption of the source driver during charging is effectively solved.
3) The timing controller is configured to execute any one of the above methods. In the method, by means of the plurality of the first voltages, the second voltages and the third voltages, when each of the switch devices is opened, at least one of the following is determined: whether the power-saving quantity of the source driver is greater than the predetermined threshold, the power-saving quantities of all of the source drivers are greater than the predetermined threshold; and if the power-saving quantity is greater than the predetermined threshold, the switch of the source driver is controlled to be closed, so as to perform charge sharing on the data channels in each of the channel groups, and the data of the next row are sent to each of the data channels. In this way, the power of the source driver during charging is saved, such that the power consumption of the entire display can be reduced, and the problem in the prior art of high power consumption of the source driver during charging is effectively solved.
4) The display system includes a display device, a source driver and a timing controller. The timing controller is configured to execute any one of the above methods, so as to control the source driver. In the method, by means of the plurality of the first voltages, the second voltages and the third voltages, when each of the switch devices is opened, at least one of the following is determined: whether the power-saving quantity of the source driver is greater than the predetermined threshold, the power-saving quantities of all of the source drivers are greater than the predetermined threshold; and if the power-saving quantity is greater than the predetermined threshold, the switch of the source driver is controlled to be closed, so as to perform charge sharing on the data channels in each of the channel groups, and the data of the next row are sent to each of the data channels. In this way, the power of the source driver during charging is saved, such that the power consumption of the entire display can be reduced, and the problem in the prior art of high power consumption of the source driver during charging is effectively solved.

The above are only the preferred embodiments of the present disclosure and are not intended to limit the disclosure. For those skilled in the art, the present disclosure may have various modifications and variations. Any modifications, equivalent replacements, improvements and the like made within the spirit and principle of the disclosure shall fall within the scope of protection of the disclosure.

What is claimed is:

1. A method for controlling a source driver, wherein there is at least one source driver to be controlled, the source driver comprises a plurality of channel groups, the channel group comprises a plurality of data channels with same polarity which are arranged in order, and any two of the plurality of the data channels in the channel group are connected by means of a switch device; and the method comprises:
an acquisition step: in a case that the source driver is in a charging state, acquiring a plurality of first voltages and a plurality of second voltages, and calculating a plurality of third voltages, wherein the first voltage is a data voltage of a current row of the data channel, the second voltage is a data voltage of a next row of the current row of the data channel, and the third voltage is a data voltage of the current row of the data channel in a case that each the switch device is closed;
a determination step: according to each of the plurality of the first voltages, each of the plurality of the second voltages corresponding to the plurality of the first voltages and each of the plurality of the third voltages corresponding to the plurality of the first voltages, determining, in a case that data of the next row are sent to the data channel after each the switch device is closed, whether at least one of following is met: whether a first power-saving quantity being greater than a first predetermined threshold, whether a second power-saving quantity being greater than a second predetermined threshold, wherein the first power-saving quantity is a power-saving quantity of the source driver, and the second power-saving quantity is a sum of power-saving quantities of all of source drivers; and
a first control step: in a case that at least one of following is met: the first power-saving quantity being greater than the first predetermined threshold, the second power-saving quantity being greater than the second predetermined threshold, controlling each the switch device of a target source driver to be closed, and then sending the data of the next row to each of the plurality of the data channels corresponding to the data of the next row, wherein the target source driver is the source driver whose the first power-saving quantity is greater than the first preset threshold, or the target source driver is all of the source drivers.

2. The method according to claim 1, wherein the plurality of the data channels are correspondingly connected to linear buffers on a one-to-one base; and in the case that the source driver is in the charging state, acquiring the plurality of the first voltages and the plurality of the second voltages, and calculating the plurality of the third voltages comprises:
in a case that the source driver is in the charging state and a inversion mode of the source driver is a column inversion mode, determining whether a display pattern corresponding to data of the current row is a preset pattern, wherein the preset pattern is a pattern displayed by a preset display device;
in a case that the display pattern is the preset pattern, reading the data voltage of the current row stored in each of the linear buffers, so as to obtain the plurality of the first voltages;
receiving video data, and extracting the data voltage of the next row from the video data, so as to obtain the second voltage; and
calculating an average value of the plurality of the first voltages of each of the plurality of the data channels in the same channel group, so as to obtain the third voltage corresponding to each of the plurality of the data channels.

3. The method according to claim 1, wherein according to each of the plurality of the first voltages, each of the plurality of the second voltages corresponding to the plurality of the first voltages and each of the plurality of the third voltages corresponding to the plurality of the first voltages, determining, in the case that the data of the next row are sent to the data channel after each the switch device is closed, whether the first power-saving quantity is greater than the first predetermined threshold comprises:
according to the first voltage, the second voltage corresponding to the first voltage and the third voltage corresponding to the first voltage, determining, in the case that the data of the next row are sent to the data channel after each the switch device is closed, whether the data channel is power-saving, and a voltage-saving quantity of the data channel, in a case that the data channel is power-saving, determining that the voltage-saving quantity is a positive number, and in a case that the data channel is not power-saving, determining that the voltage-saving quantity is a negative number;
adding each of voltage-saving quantities corresponding to the source driver, so as to obtain the first power-saving quantity; and
determining whether the first power-saving quantity is greater than the first predetermined threshold.

4. The method according to claim 3, wherein according to the first voltage, the second voltage corresponding to the first voltage and the third voltage corresponding to the first voltage, determining, in the case that the data of the next row are sent to the data channel after each the switch device is closed, whether the data channel is power-saving comprises:
in a case that the first voltage, the third voltage and the second voltage are increased or decreased in order, determining, in the case that the data of the next row are sent to the data channel after each the switch device is closed, that the data channel is power-saving; and
in a case that the third voltage is separately greater than or less than the first voltage and the second voltage, determining, in the case that the data of the next row are sent to the data channel after each the switch device is closed, that the data channel is not power-saving.

5. The method according to claim 4, wherein determining, in the case that the data of the next row are sent to the data channel after each the switch device is closed, the voltage-saving quantity of the data channel comprises:
in a case that the data channel is power-saving, determining that the voltage-saving quantity is an absolute value of a difference between the first voltage and the third voltage;
in a case that the data channel is not power-saving and both the second voltage and the third voltage are greater than or less than the first voltage, determining that the voltage-saving quantity is a negative number of the absolute value of the difference between the first voltage and the third voltage; and
in a case that the data channel is not power-saving and both the second voltage and the third voltage are not greater than or less than the first voltage, determining that the voltage-saving quantity is a negative number of an absolute value of a difference between the second voltage and the third voltage.

6. The method according to claim 1, wherein there are a plurality of the source drivers; and according to each of the plurality of the first voltages, each of the plurality of the second voltages corresponding to the plurality of the first voltages and each of the plurality of the third voltages corresponding to the plurality of the first voltages, determining, in the case that the data of the next row are sent to the data channel after each the switch device is closed, whether the second power-saving quantity is greater than the second predetermined threshold comprises:
determining each the first power-saving quantity according to each of the plurality of the first voltages, each of the plurality of the second voltages corresponding to the plurality of the first voltages and each of the plurality of the third voltages corresponding to the plurality of the first voltages; and
adding first power-saving quantities, so as to obtain the second power-saving quantity, and determining whether the second power-saving quantity is greater than the second predetermined threshold.

7. The method according to claim 1, wherein the source driver further comprises a control module; and controlling each the switch device of the target source driver to be closed comprises:
generating a data packet, and sending the data packet to the control module of the target source driver, wherein the data packet is used for instructing the control module of the target source driver to close each the switch device.

8. The method according to any of claims 1 to 7, wherein in a case that the first power-saving quantity is less than or equal to the first predetermined threshold, or the second power-saving quantity is less than or equal to the second predetermined threshold, the method further comprises:
a second control step: controlling each the switch device of the target source driver to turn off, and then sending the data of the next row to each of the plurality of the data channels corresponding to the data of the next row.

9. The method according to claim 8, the method further comprising:
successively executing the acquisition step, the determination step, and the first control step or the second control step for at least once, until all row data of video data are sent to the plurality of the data channels corresponding to the data of the next row.

10. An apparatus for controlling a source driver, wherein there is at least one source driver to be controlled, the source driver comprises a plurality of channel groups, the channel group comprises a plurality of data channels with same polarity which are arranged in order, and any two of the plurality of the data channels in the channel group are connected by means of a switch device; and the apparatus comprises:
an acquisition component, configured to perform an acquisition step: in a case that the source driver is in a charging state, acquiring a plurality of first voltages and a plurality of second voltages, and calculating a plurality of third voltages, wherein the first voltage is a data voltage of a current row of the data channel, the second voltage is a data voltage of a next row of the current row of the data channel, and the third voltage is a data voltage of the current row of the data channel in a case that each the switch device is closed;
a determination component, configured to perform a determination step: according to each of the plurality of the first voltages, each of the plurality of the second voltages corresponding to the plurality of the first voltages and each of the plurality of the third voltages corresponding to the plurality of the first voltages, determining, in a case that data of the next row are sent to the data channel after each the switch device is closed, whether at least one of following is met: whether a first power-saving quantity being greater than a first predetermined threshold, whether a second power-saving quantity being greater than a second predetermined threshold, wherein the first power-saving quantity is a power-saving quantity of the source driver, and the second power-saving quantity is a sum of power-saving quantities of all of source drivers; and
a first control component, configured to perform a first control step: in a case that at least one of following is met: the first power-saving quantity being greater than the first predetermined threshold, the second power-saving quantity being greater than the second predetermined threshold, controlling each the switch device of a target source driver to be closed, and then sending the data of the next row to each of the plurality of the data channels corresponding to the data of the next row, wherein the target source driver is the source driver whose the first power-saving quantity is greater than the first preset threshold, or the target source driver is all of the source drivers.

11. A computer-readable storage medium, comprising a program stored, wherein the program executes the method according to any of claims 1 to 9.

12. A processor, configured to operate a program, wherein the method according to any of claims 1 to 9 is executed when the program is operated.

13. A timing controller, comprising one or more processors, a memory, and one or more programs, wherein the one or more programs are stored in the memory, and are configured to be executed by the one or more processors; and the one or more programs comprise instructions that are used for executing the method according to any of claims 1 to 9.

14. A display system, comprising:
a display device;
at least one source driver, of which output is connected to the display device, wherein the source driver comprises a plurality of channel groups, the channel group comprises a plurality of data channels with same polarity which are arranged in order, and any two of the plurality of the data channels in the channel group are connected by means of a switch device; and
the timing controller according to claim 13, connected to an input of the source driver.

15. The display system according to claim 14, wherein each of the plurality of the channel groups separately has three of the data channels.
